(19) United States
(12) Patent Application Publication
(10) Pub. No.: US 2018/0001583 A1
(43) Pub. Date: Jan. 4, 2018

(54) APPARATUS AND METHOD FOR PRODUCING A RUBBER CATERPILLAR TRACK WITH TENSILE MEMBERS

(71) Applicant: Contitech Transportbandsysteme GmbH, Hannover (DE)

(72) Inventors: Achim Huels, Barsinghausen (DE); Carsten Behrens, Bilshausen (DE)

(21) Appl. No.: 15/709,094

(22) Filed: Sep. 19, 2017

Related U.S. Application Data
(63) Continuation of application No. PCT/EP2016/050636, filed on Jan. 14, 2016.

(30) Foreign Application Priority Data
Mar. 20, 2015 (DE) 102015205071.8

(51) Int. Cl. B29D 29/00; B29C 43/46; B29C 35/02

(52) U.S. Cl. CPC B29D 29/00; B29C 35/0277; B29C 43/46

(57) ABSTRACT

An apparatus for producing a rubber caterpillar track with tensile members has a cylindrical internal shape for forming the inside contour of the rubber caterpillar track, wherein the internal shape has a cylindrical dome which, in the circumferential direction (U) on its radial outer side, has a plurality of recesses for accommodating unvulcanized shaped elements for internal teeth, and has a cylindrical external shape for forming the outside contour of the rubber caterpillar track, wherein the external shape has a plurality of external shape segments in the circumferential direction (U). The external shape segments each have a recess on their radial inner side for accommodating an unvulcanized shaped element for external teeth. The invention further relates to a method for producing a rubber caterpillar track with tensile members.

### CROSS REFERENCE TO RELATED APPLICATIONS

This application is a continuation application of international patent application Ser. No. PCT/EP2016/050636, filed Jan. 14, 2016 designating the United States and claiming priority from German application 10 2015 205 071.8, filed Mar. 20, 2015, and the entire content of both applications is incorporated herein by reference.

### FIELD OF THE INVENTION

The invention relates to a device for producing a rubber caterpillar track with tensile and to a method for producing a rubber caterpillar track using a device of this type.

### BACKGROUND OF THE INVENTION

Known drive mechanisms for land vehicles include, inter alia, caterpillar tracks. These may be utilized not only in the military sector but also for agricultural vehicles and for other vehicles for transportation on rough terrain. Caterpillar tracks commonly have inwardly projecting tooth elements on their inside, preferably in the center, via which tooth elements the caterpillar track can be engaged on and propelled by a drive wheel or the like of the vehicle. On their outside, caterpillar tracks commonly have a profiling for permitting better purchase on the underlying surface. This profiling may be realized similarly to a tractor tire, for example, that is the profiling may have beam-like radial elevations which are arranged on the caterpillar track obliquely with respect to the running direction of the caterpillar track. The internally situated tooth elements and the externally situated profiling elements are commonly connected by a caterpillar track body which is of endless closed form.

Caterpillar tracks may be produced from rubber, and are then referred to as rubber caterpillar tracks. Caterpillar tracks may be produced so as to be of endless closed configuration or of open configuration. They may have a tensile member, for example in the form of steel cables, for transmitting tensile forces, which tensile member may be arranged so as to run around several times in the running direction. Transverse reinforcements may be provided which assist in transmitting the forces across the width of the caterpillar track. The tensile members and/or transverse reinforcements are normally enclosed in, for example by being vulcanized into, the caterpillar track body.

To produce rubber caterpillar tracks, it is known for example from U.S. Pat. No, 6,086,811 for unvulcanized rubber elements to be placed into corresponding recesses of a cylindrical inner mold, which unvulcanized rubber elements are intended to later form the internal teeth of the rubber caterpillar track. The caterpillar track body made of unvulcanized rubber, with tensile members embedded therein, is then applied, for example by winding, over the unvulcanized internal teeth or the outer surface of the inner mold. Here, the caterpillar track body is of such thick construction in a radially outward direction that the outside profiling can be formed out of the radially outer unvulcanized material. This is performed by virtue of a cylindrical outer mold, which on its inside has the external contour of the profiling, and the unvulcanized rubber caterpillar track being pressed against one another, such that the externally situated unvulcanized material is deformed to form the profiling. The vulcanization is then performed within the press.

During the production of a rubber caterpillar track as per U.S. Pat. No. 6,177,042 B1, the internal teeth are formed as unvulcanized rubber elements and placed into the corresponding apertures of a cylindrical inner mold. The other bodies of the rubber caterpillar track are constructed in unvulcanized form separately and then placed onto the inner mold. By virtue of the inner mold and outer mold being pressed together, the internal teeth are pressed from the inside against the body of the rubber caterpillar track, and on the outside of the rubber caterpillar track, the outer shaped segments are formed by pressure. The vulcanization is then performed within the press. Here, the inner mold and the outer mold are of segmented construction, wherein the segments are initially arranged spaced apart from one another in a circumferential direction and, during the course of the vulcanization, are pressed together so as to yield a cylindrical closed shape.

A disadvantage of the two above-described methods is that the external contour of the rubber caterpillar track is formed by pressing of the unvulcanized body of the rubber caterpillar track. Since the tensile members are however arranged in the unvulcanized body of the rubber caterpillar track and the pressing of the unvulcanized material causes the material to be deformed almost exclusively in the radially outer region of the body of the rubber caterpillar track, this can result in the tensile members being displaced out of their original arrangement. In this way, after the vulcanization, the tensile members may no longer be taut in the circumferential direction and arranged in the neutral phase, whereby their action of transmitting tensile force in the longitudinal direction of the rubber caterpillar track may be restricted. This can lead to tearing of the rubber caterpillar track and reduce the service life of the rubber caterpillar track.

U.S. Pat. No. 3,934,968 A relates to a mold and to a method for producing double-sided toothed belts. An inner mold with apertures on its outer side for forming the internal teeth of the double-sided tooth belt is referred to here as mandrel. The outer mold is of segmented form, wherein each segment can form two tooth halves and the space between two adjacent teeth of the external teeth. The segments are held together via a deformable jacket and can hereby also be pressed together in order to form an outer mold which is closed in a circumferential direction. The segments have laterally projecting pegs via which they can be guided in a radial direction with respect to the inner mold in radial slots formed therein. The apertures for forming the internal teeth and the external teeth are formed so as to be of equal size.

To form a double-sided toothed belt, the body of the double-sided toothed belt, which is of endless closed form in the circumferential direction, is constructed on the outer surface of the inner mold, wherein, in this case too, tensile members are arranged in the body of the double-sided toothed belt. Then, the segments of the outer mold are pulled together by the jacket, and the outer mold is hereby closed. As a result of the closure of the mold, the enclosed elastomer material is, via internal flow processes, pressed under pressure into the apertures of the inner mold and outer mold and hereby forms the teeth of the double-sided toothed belt. The vulcanization is then performed within the press. Here, excess elastomer material or enclosed air can, owing to the pressure, escape through the pinions which between them form the segments, whereby this distribution of the segmentation should be selected owing to the method.

In this production process, a displacement of the tensile members is also possible, but is not to be expected at least if the internal teeth and external teeth are of approximately equal size, such that the elastomer material that is pressed in is forced uniformly radially inward and radially outward relative to the position of the tensile members and, as a result, the position of the tensile members is not, or not significantly, changed.

This however applies only in the case of internal teeth and external teeth of substantially equal size or if the apertures of the inner mold and outer mold for forming the teeth are of equal size, because it is only then that the pressure of the elastomer material can distribute uniformly. Therefore, the method of U.S. Pat. No. 3,934,968 A can be applied to the production of rubber caterpillar tracks only with the disadvantages described with regard to U.S. Pat. Nos. 6,086,811 and 6,177,042 B1, because in the case of a rubber caterpillar track, relatively small internal teeth and relatively large external profiles are formed. Furthermore, the internal teeth are generally arranged in a narrow central region, and the external profiles extend over the entire width of the rubber caterpillar track, normally even obliquely with respect to the running direction.

Thus, pressing of an elastomer material into a mold of U.S. Pat. No. 3,934,968 A, which is used for the production of rubber caterpillar tracks, would lead to a very extreme displacement of the tensile members out of their original arrangement, with the corresponding disadvantages. This displacement of the tensile members would even be more extreme than in the case of the production methods of U.S. Pat. Nos. 6,177,042 B1 and 6,086,811 A, because in the methods, there is already elastomer material in the apertures during the pressing-together of the two molds, whereas in the case of U.S. Pat. 3,934,968 A, the elastomer material must be pressed under pressure into the apertures of the two molds, which greatly increases the likelihood and the extent of displacement of the tensile members.

Also, the teeth of a double-sided toothed belt, with a radial height of approximately 3 to 5 mm, are of considerably smaller form than the teeth of a rubber caterpillar track or for agricultural vehicles. Here, the teeth may have a radial height of for example 70 mm. Thus, if the method of U.S. Pat. No. 3,934,968 A were applied to a rubber caterpillar track, much longer flow paths of the pressed-in elastomer material would also arise, as a result of which more extreme displacement of the tensile members could also occur.

### SUMMARY OF THE INVENTION

It is therefore an object of the present invention to provide an apparatus and a method for producing a rubber caterpillar track having tensile members, such that rubber caterpillar tracks with tensile members can be produced easily and inexpensively without the possibility of a displacement of the tensile members during the production process. It is at least sought to be able to reduce the displacement of the tensile members.

The object can, for example, be achieved via an apparatus for making a rubber caterpillar track with tensile members. The apparatus includes: a cylindrical inner mold configured to form the inner contour of the rubber caterpillar track; the cylindrical inner mold having a cylindrical mandrel defining a radially outer side and a circumferential direction U; the cylindrical mandrel defining a plurality of first recesses on the radially outer side in the circumferential direction U; the first recesses being configured to receive unvulcanized shaped elements for inner teeth; a cylindrical outer mold configured to form an outer contour of the rubber caterpillar track; the cylindrical outer mold having a multiplicity of outer mold segments; the outer mold segments each defining a radially inner side; and, the outer mold segments each having a second recess configured to receive an unvulcanized shaped element for outer teeth on the radially inner side.

The object can, for example, further be achieved via a method for making a rubber caterpillar track using an apparatus having a cylindrical inner mold configured to form the inner contour of the rubber caterpillar track, the cylindrical inner mold having a cylindrical mandrel defining a radially outer side and a circumferential direction U, the cylindrical mandrel defining a plurality of first recesses on the radially outer side in the circumferential direction U, the first recesses being configured to receive unvulcanized shaped elements for inner teeth, a cylindrical outer mold configured to form an outer contour of the rubber caterpillar track, the cylindrical outer mold having a multiplicity of outer mold segments, the outer mold segments each defining a radially inner side, and the outer mold segments each having a second recess configured to receive an unvulcanized shaped element for outer teeth on the radially inner side. The method includes the steps of: introducing unvulcanized shaped elements for the inner teeth into corresponding first recesses of the cylindrical mandrel of the cylindrical inner mold; applying an unvulcanized body of the rubber caterpillar track with tensile members onto the shaped elements for the inner teeth and the radially outer side of the mandrel; introducing unvulcanized shaped elements for outer teeth into corresponding second recesses of the cylindrical outer mold; assembling the cylindrical inner mold and the cylindrical outer mold; and, vulcanizing the body of the rubber caterpillar track with the unvulcanized shaped elements for the inner teeth and the unvulcanized shaped elements for the outer teeth.

The present invention thus relates to a device for producing a rubber caterpillar track with tensile members, which device is characterized in that the outer mold segments each have, on their radial inner side, a recess for receiving an unvulcanized shaped element for external teeth.

The invention is based on the realization that the external teeth of a rubber caterpillar track can be produced more easily and less expensively with the aid of profiled shape elements than by pressing the outside profiling out of the unvulcanized material of the body of the rubber caterpillar track. This production of identical shaped elements for one type of rubber caterpillar track can be performed in large quantities and thus inexpensively.

It is also advantageous that, as a result of the caterpillar track for vulcanization being constructed from shaped elements as teeth, the pressing pressure can be reduced to a minimum and can be achieved via a jacket in an autoclave. The vulcanization can therefore be performed in an autoclave, which can considerably reduce the production costs.

It is advantageous in particular that, as a result of the omission of pressing of the shaped parts or pressing of the elastomer material into the mold, a displacement of the tensile members as a result of the flows of the elastomer material within the mold can be reduced or prevented. Here, tensile members are to be understood to mean both the closed steel cables wound in endless fashion in the running direction of the rubber caterpillar track and also transverse reinforcements et cetera in the transverse direction. This can improve the durability and longevity of the rubber caterpillar track.

Here, the external segments may be assembled with one another to form a closed chain running in a circumferential direction, or else may be arranged individually and loosely in the circumferential direction and/or laterally adjacent to one another. Here, the external segments may in each case be formed so as to be continuous, or formed only in sections, over the width, such that multiple external segments laterally adjacent to one another can cover the width of the body of the rubber caterpillar track. It is possible for identical external segments or different external segments to be used with one another, such that the configuration of the profiling of the external teeth can be configured in this way.

According to one aspect of the present invention, the outer mold segments may be held together in the circumferential direction, and pressed together from radially outside, by a deformable jacket. In this way, the outer mold segments can be held in position with respect to one another. Also, pressure can be exerted on the outer mold segments via the jacket.

According to a further aspect of the present invention, the outer mold segments are mounted so as to be radially movable relative to the inner mold. This allows the outer mold segments to move radially inward under the pressing action of the jacket. Furthermore, manufacturing differences between the individual shaped elements can be compensated in this way.

According to a further aspect of the present invention, the outer mold segments have an opening radially toward the outside. The opening serves for pressure equalization during the pressing-together of the outer mold segments, that is the unvulcanized material of the shaped elements for external teeth can escape radially outward through the opening if necessary. The radial outer surface of the mold element can then press against the inside of the jacket, such that the escape is limited. This radial excess length of the vulcanized external teeth has no influence on the quality of the rubber caterpillar track, because the side of the rubber caterpillar track wears during use, and the excess length is thus worn down.

The opening is preferably of areal configuration in order to prevent movements in the elastomer material other than in the radial direction, because this could result in a displacement of the tensile members.

According to a further aspect of the present invention, the opening substantially corresponds to the radially outer surface of an unvulcanized shaped element for external teeth. In this way, movements in the elastomer material other than in the radial direction can be prevented.

The present invention also relates to a method for producing a rubber caterpillar track using a device as described above. In this way, the advantages of the device according to the invention can be utilized in the production of rubber caterpillar tracks.

### BRIEF DESCRIPTION OF THE DRAWINGS

The invention will now be described with reference to the drawings wherein:

FIG. 1 is a perspective schematic illustration of a device according to the invention without rubber caterpillar track;

FIG. 2 shows the view of FIG. 1 with inserted unvulcanized shaped elements for internal teeth and unvulcanized body of the rubber caterpillar track;

FIG. 3 shows the view of FIG. 2 with placed-on unvulcanized shaped elements for external teeth;

FIG. 4 shows the view of FIG. 3 with outer mold segments;

FIG. 5 shows the view of FIG. 4 with placed-on, spaced-apart jacket; and,

FIG. 6 shows the view of FIG. 5 with pulled-together jacket.

### DESCRIPTION OF THE PREFERRED EMBODIMENTS OF THE INVENTION

The device has an inner mold 1 which is of cylindrical form and which extends over a width B and in a circumferential direction U. The inner mold 1 has a cylindrical mandrel 10, laterally on the outer surface of which in a radial direction R there is formed, in the center, a multiplicity of apertures or recesses 11 for receiving unvulcanized shaped elements for internal teeth 30 of a rubber caterpillar track 3. The radial outer surface of the mandrel 10 is delimited laterally in terms of width B by lateral delimitations 12 which each have radial slots 13.

The device furthermore has an outer mold 2 which has a multiplicity of outer mold segments 21 which together form a cylindrical arrangement. The outer mold segments 21 are held from radially outside by a deformable jacket 20 and can be pressed together in a radially inward direction by the jacket. Each outer mold segment 21 has a recess 22 which corresponds to the contour of an unvulcanized shaped element for an external tooth 31. Here, the outer mold segments 21 are of areally open form in a radially outward direction such that the outer surface of the unvulcanized shaped element for an external tooth 31 can project radially outward out of the opening 24 and, there, can come into contact with the inner surface of the jacket 20.

For the guidance of the outer mold segments 21, these each have guide elements 23 in the form of pegs 23 which extend from the outer mold segments 21 in the width direction B and engage into the radial slots 13 of the lateral delimitations 12. In this way, the outer mold segments 21 are prevented from moving in the circumferential direction U and are thus positioned in this direction. However, mobility within the slot 13 is provided in the radial direction R, such that height compensation in the radial direction R is possible.

As a result of the device, a rubber caterpillar track 3 with tensile members 33 can now be produced as follows:

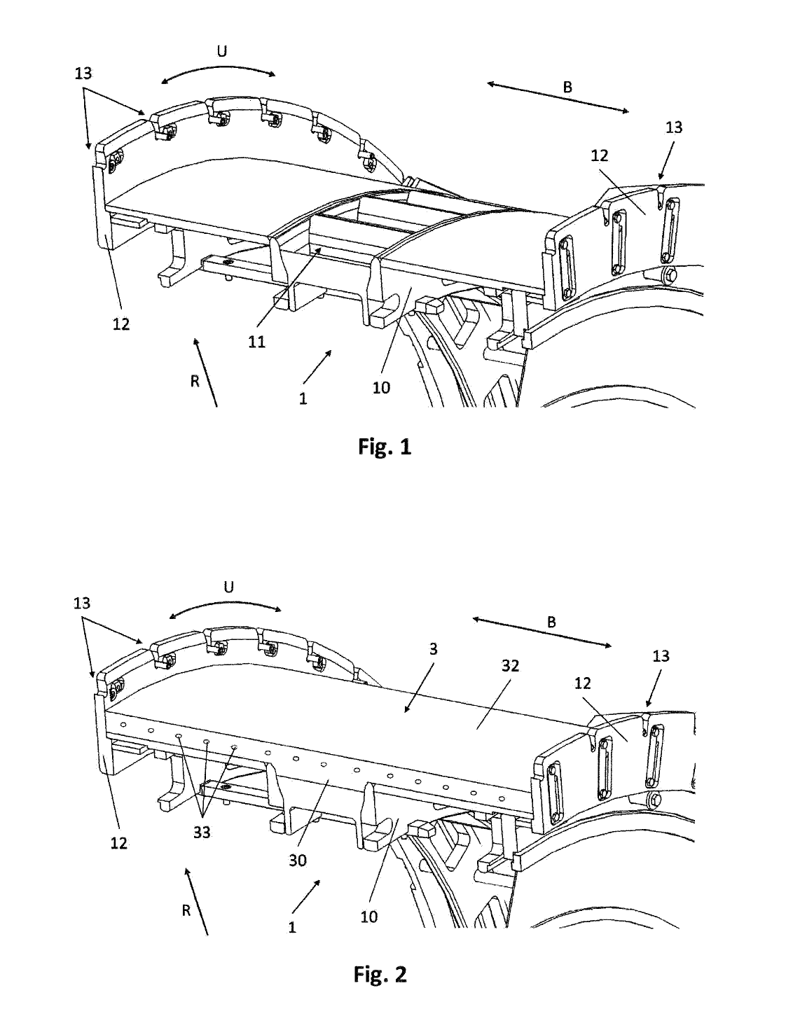

The unvulcanized shaped elements for internal teeth 30 are inserted into the recesses 11 of the inner mold 10 (see FIG. 1) such that the shaped elements fill the recesses and, radially at the outside, terminate in as flush a manner as possible with the outer surface of the mandrel 10. Then, on the outer surface of the mandrel 10, the unvulcanized body 32 of the rubber caterpillar track 3 is constructed from layers of elastomer material and tensile members 33 embedded therein, such that the unvulcanized shaped elements for internal teeth 30 and the unvulcanized body 32 are as far as possible in complete areal contact with one another (see FIG. 2).

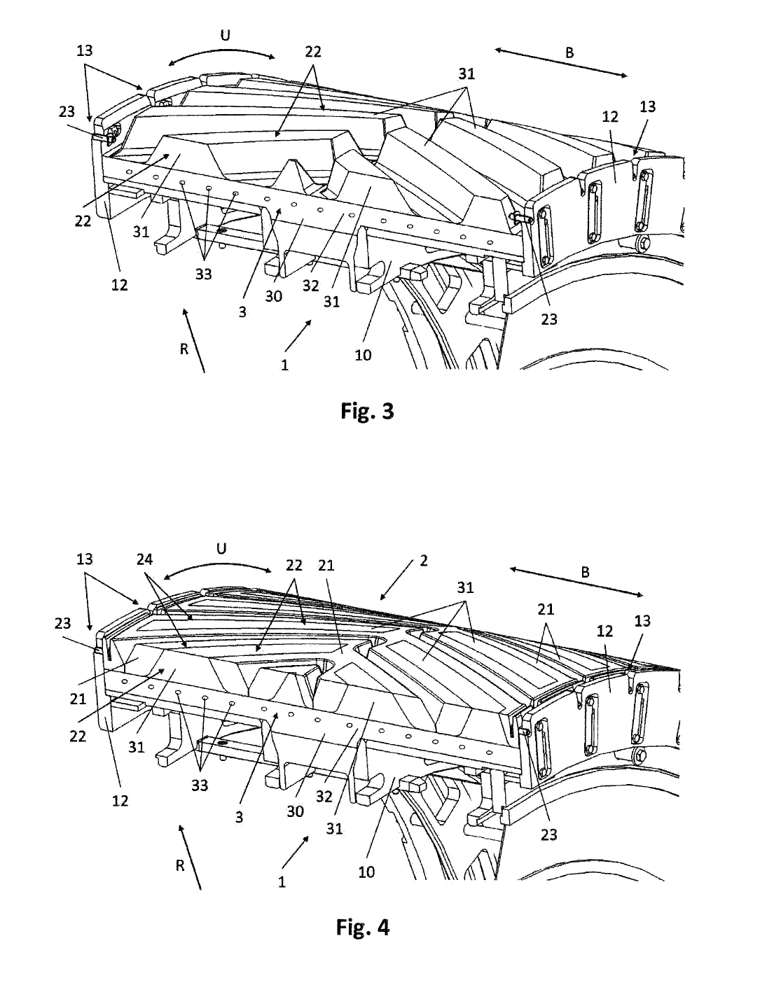

In parallel, the outer mold segments 21 are assembled to form a chain correspondingly to the circumference of the outer surface of the unvulcanized body 32 of the rubber caterpillar track 3, and the unvulcanized shaped elements for external teeth are inserted into the recesses 22. The chain of outer mold segments 21 is then rolled onto the unvulcanized body 32 of the rubber caterpillar track 3, such that the pegs 23 engage into the radial slots 13 (see FIGS. 3 and 4).

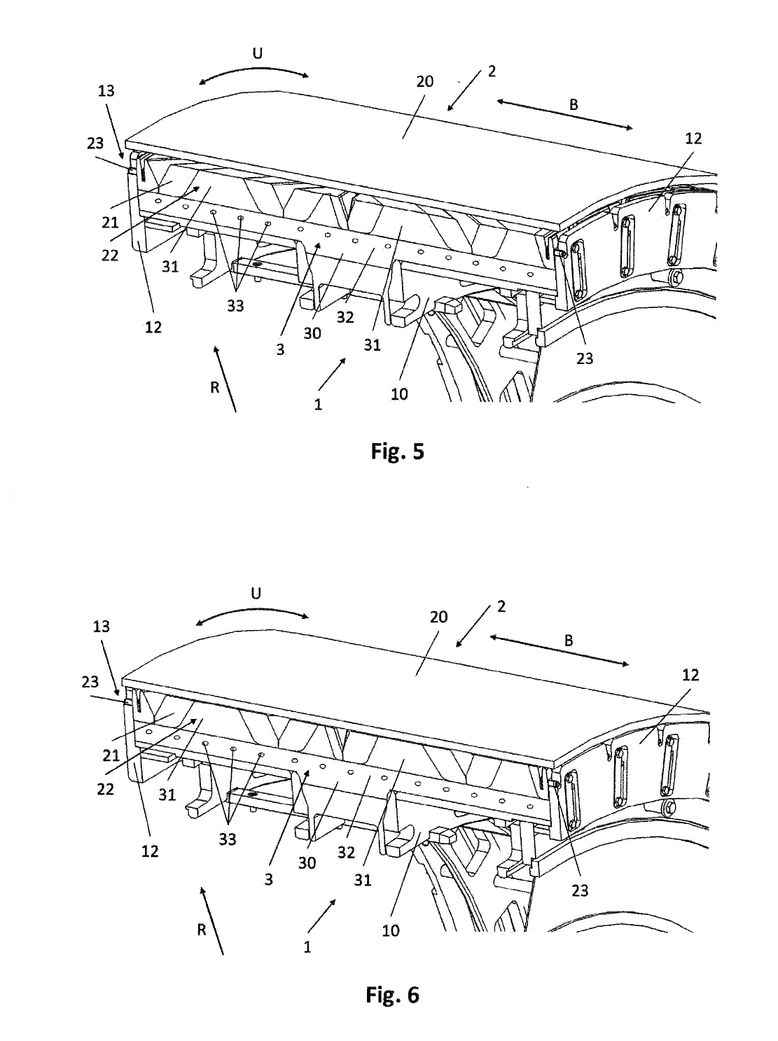

Then, the jacket 20 is laid around the outer mold segments 21 (see FIG. 5) and is subsequently pulled together (see FIG. 6), such that the unvulcanized shaped elements for internal teeth 30, the unvulcanized body 32 of the rubber caterpillar track 3 and the unvulcanized shaped elements 31 for external teeth are pressed radially against one another and are held in this state. Here, elastomer material of the unvulcanized shaped elements of the external teeth 31 can be forced radially outward through the openings 24 of the outer mold segments 21 against the inner side of the jacket 20 in order to compensate deviations of the shaped elements of the external teeth 31.

In this state, the unvulcanized rubber caterpillar track 3 can be vulcanized, wherein this can be performed in an autoclave, because, in accordance with the device according to the invention and the corresponding method, it is not necessary for a high pressure to be exerted on the unvulcanized elements 30, 31, 32 for the purposes of shaping the rubber caterpillar track 3. Also, there is no need for unvulcanized material to be pressed into the mold 1, 2. In this way, it is possible to prevent flows of the elastomer material within the mold from resulting in displacements of the tensile members 33, which could move these out of the desired position such as the neutral phase.

Rather, according to the invention, the unvulcanized elements 30, 31, 32 are compressed by the pressure of the jacket 20 only to such an extent that the contact surfaces with respect to one another reliably remain joined together during the vulcanization process, and can thus be cohesively connected by the vulcanization process. The pressure of the jacket 20 is however too low to be able to effect flows of the elastomer material within the pre-molded unvulcanized elements 30, 31 and 32 and thereby effect relatively great displacements of the tensile members 33, as a result of which such displacements can, according to the invention, be avoided.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Description

B Width
R Radial direction, radius
U Circumferential direction
1 Inner mold
10 Mandrel
11 Recesses of the mandrel 10
12 Lateral delimitation
13 Radial slots of the lateral delimitation 12
2 Outer mold
20 Jacket
21 Outer mold segments, jacket segments
22 Recesses or recesses of the outer mold segments 21
23 Guide elements or pegs of the outer mold segments 21
24 Openings of the outer mold segments 21
3 Rubber caterpillar track
30 Unvulcanized shaped elements for internal teeth, tooth ribs, internal teeth
31 Unvulcanized shaped elements for external teeth, profile ribs, external teeth, profiling
32 Unvulcanized body of the rubber caterpillar track 3
33 Tensile members

What is claimed is:

1. An apparatus for making a rubber caterpillar track having tensile members, the apparatus comprising:
a cylindrical inner mold configured to form the inner contour of the rubber caterpillar track;
said cylindrical inner mold having a cylindrical mandrel defining a radially outer side and a circumferential direction U;
said cylindrical mandrel defining a plurality of first recesses on said radially outer side in said circumferential direction U;
said first recesses being configured to receive unvulcanized shaped elements for inner teeth;
a cylindrical outer mold configured to form an outer contour of the rubber caterpillar track;
said cylindrical outer mold having a multiplicity of outer mold segments;
said outer mold segments each defining a radially inner side; and,
said outer mold segments each having a second recess configured to receive an unvulcanized shaped element for outer teeth on said radially inner side.

2. The apparatus of claim 1 further comprising a deformable jacket configured to hold said outer mold segments together in said circumferential direction U and to press said outer mold segments together from radially outward.

3. The apparatus of claim 1, wherein said outer mold segments are mounted in a radially moveable manner with respect to said cylindrical inner mold.

4. The apparatus of claim 1, wherein said outer mold segments define an opening in a radially outward direction.

5. The apparatus of claim 4, wherein:
said unvulcanized shaped element for said outer teeth defines a radially outer surface; and,
said opening essentially corresponds to said radially outer surface of said unvulcanized shaped element.

6. A method for making a rubber caterpillar track using an apparatus having a cylindrical inner mold configured to form the inner contour of the rubber caterpillar track, the cylindrical inner mold having a cylindrical mandrel defining a radially outer side and a circumferential direction U, the cylindrical mandrel defining a plurality of first recesses on the radially outer side in the circumferential direction U, the first recesses being configured to receive unvulcanized shaped elements for inner teeth, a cylindrical outer mold configured to form an outer contour of the rubber caterpillar track, the cylindrical outer mold having a multiplicity of outer mold segments, the outer mold segments each defining a radially inner side, and the outer mold segments each having a second recess configured to receive an unvulcanized shaped element for outer teeth on the radially inner side, the method comprising the steps of:
introducing unvulcanized shaped elements for said inner teeth into corresponding first recesses of the cylindrical mandrel of the cylindrical inner mold;
applying an unvulcanized body of the rubber caterpillar track with tensile members onto the shaped elements for said inner teeth and the radially outer side of the mandrel;
introducing unvulcanized shaped elements for outer teeth into corresponding second recesses of said cylindrical outer mold;
assembling the cylindrical inner mold and the cylindrical outer mold; and,
vulcanizing the body of the rubber caterpillar track with the unvulcanized shaped elements for the inner teeth and the unvulcanized shaped elements for the outer teeth.
